(19) United States
(12) Patent Application Publication
(10) Pub. No.: US 2024/0144074 A1
(43) Pub. Date: May 2, 2024

(54) METHODS, SYSTEMS, ARTICLES OF MANUFACTURE AND APPARATUS TO MANAGE TRAINING FOR MACHINE LEARNING MODELS

(71) Applicant: Nielsen Consumer LLC, Chicago, IL (US)

(72) Inventors: Roberto Arroyo, Madrid (ES); Javier Lorenzo Díaz, Chicago, IL (US); Héctor Corrales Sánchez, Madrid (ES); Elena Martínez, Chicago, IL (US); Jose Javier Yebes Torres, Valladolid (ES)

(21) Appl. No.: 17/976,058

(22) Filed: Oct. 28, 2022

(51) Int. Cl. G06N 20/00; G06F 11/34

(52) U.S. Cl. CPC G06N 20/00; G06F 11/3495

(57) ABSTRACT

Methods, apparatus, systems, and articles of manufacture are disclosed for managing training for models. An example apparatus includes a processor circuitry to at least obtain a request to train or retrain a model, respond to the request by preventing the train or retraining, calculate at least one performance metric, and compare performance metric corresponding to current model execution to at least one threshold performance metric.

### FIELD OF THE DISCLOSURE

This disclosure relates generally to artificial intelligence/machine learning models and, more particularly, to methods, systems, articles of manufacture and apparatus to manage training for machine learning models.

### BACKGROUND

In recent years, text processing and text understanding have become a task performed by varied artificial intelligence systems. Machine learning models have allowed for the automation of data collection methods, in which the collected data includes images having text.

### BRIEF DESCRIPTION OF THE DRAWINGS

FIG. 1 is a block diagram of an example environment to train models structured in accordance with teachings of this disclosure.

FIG. 2 is a block diagram of an example model management circuitry of FIG. 1 structured in accordance with the teachings of this disclosure.

FIGS. 3A and 3B are flowcharts representative of example machine readable instructions and/or example operations that may be executed by example processor circuitry to implement the model management circuitry of FIGS. 1 and 2.

FIG. 4 is a block diagram of an example processing platform including processor circuitry structured to execute the example machine readable instructions and/or the example operations of FIGS. 3A and 3B to implement the model management circuitry of FIGS. 1 and 2.

FIG. 5 is a block diagram of an example implementation of the processor circuitry of FIG. 4.

FIG. 6 is a block diagram of another example implementation of the processor circuitry of FIG. 4.

FIG. 7 is a block diagram of an example software distribution platform (e.g., one or more servers) to distribute software (e.g., software corresponding to the example machine readable instructions of FIGS. 3A and 3B to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

In artificial intelligence systems, automated model training for machine learning models is a valuable asset. Machine learning models provide the ability to automate data collection. In some instances, the machine learning models are utilized to decode documents or images with text. Common state-of-the-art approaches related to model training may automate the management of retrieving data, training models, and regularly retraining models. However, this is problematic because it leads to unnecessary retraining of models. In the current state of the art, models are retrained based on a schedule or, in some examples, a particular periodic basis. In consequence, the current approach to train and retrain models, without testing to confirm the training is required, demands valuable engineering resources. Additionally, the computer resources to train and retrain models is tolling due to the amount of computational resources (e.g., graphical processing unit (GPU) resources, central processing unit (CPU) resources, field programmable gate array (FPGA) resources, accelerator resources, etc.) required. Examples disclosed herein involve the process of model training, management of the models, and blocking models from being erroneously retrained when performance indicators dictate retraining is unnecessary. Consequently, there are energy savings because models are only trained when objective indictors and/or thresholds establish that training is needed.

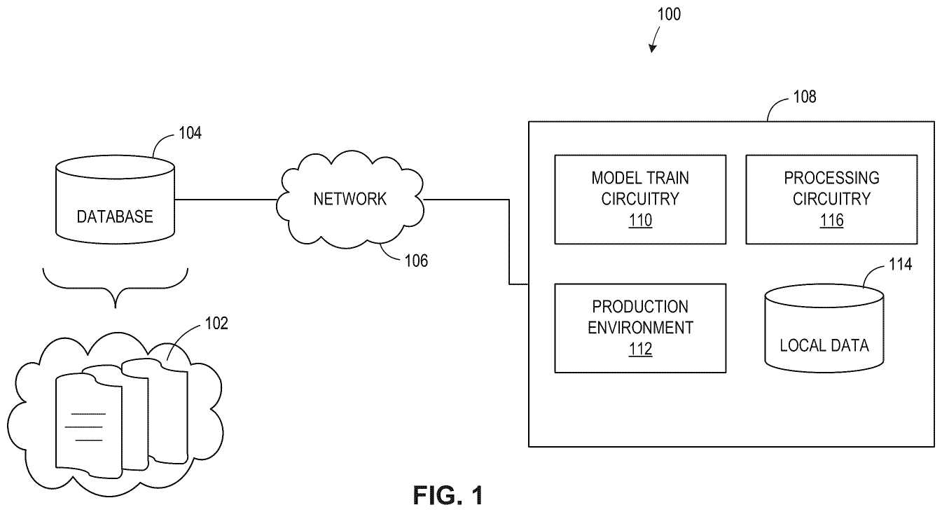

FIG. 1 is a schematic illustration of an example environment to train models 100. In the illustrated example of FIG. 1, the environment to train models 100 includes example data 102, an example database 104, an example network 106, an example processor platform(s) 108, example model management circuitry 110, an example production environment 112, example local data storage 114, and example processing circuit(s) 116.

As described above, the example environment to train models 100 addresses problems related to wasteful computational processing associated with model training and/or re-training. Generally speaking, existing approaches apply computational resources to model training and/or re-training efforts that are absent of any consideration of whether such efforts are needed in view of one or more objective tests and/or metrics. For instance, typical approaches may train and/or re-train models on an automatic basis, a periodic basis, or a scheduled basis. In some examples, models and/or data corresponding to the models (e.g., parameter values, coefficient values, etc.) may include example data 102 stored in the example database 104. In some examples, local data storage 114 is stored on the processor platform(s) 108. While the illustrated example of FIG. 1 shows a single database 104, examples disclosed herein are not limited thereto. For instance, any number and/or type of data storage may be implemented that is communicatively connected to any number and/or type of processor platform(s) 108, either directly and/or via the example network 106.

As described in further detail below, the example model management circuitry 110 evaluates a process (e.g., one or more processes executing on computing resources) that utilizes models in the production environment 112. As described in further detail below, the example model management circuitry 110 (and/or other circuitry therein) detects, retrieves, receives and/or obtains instances (e.g., requests) corresponding to model training and/or retraining tasks. As used herein, a production environment represents one or more operations, tasks, routines and/or executable processes instantiated by the example processor platform(s) 108. In some examples, the processor platform(s) 108 instantiates an executable that relies upon and/or otherwise utilizes one or more models in an effort to complete an objective, such as translating text from images. While the illustrated example of FIG. 1 shows a single instantiated production environment 112, examples disclosed herein are not limited thereto. Rather than allow such processes to continue with performing such training and/or re-training tasks, examples disclosed herein verify that such tasks are appropriate in view of any number of metrics and/or tests, thereby conserving processing resources, facilitating faster process execution and/or helping green energy conservation initiatives.

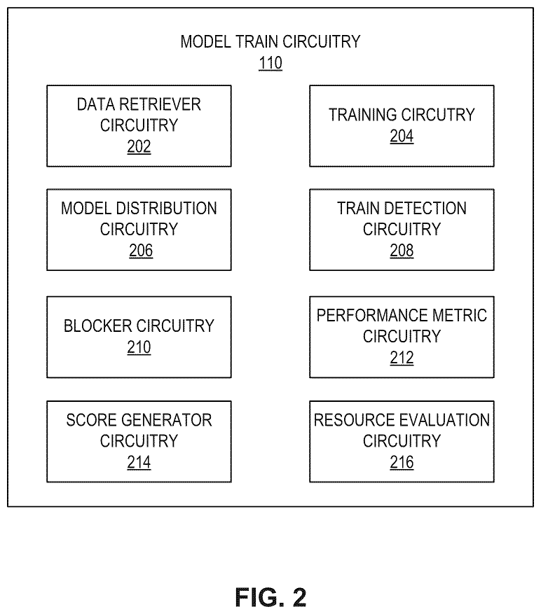

In the illustrated example of FIG. 1, the database 104 includes data 102 for storage and/or download. In some examples, the database 104 can be cloud storage. To perform training of the models (e.g., for the benefit of the one or more production environments 112), example data retriever circuitry 202 (described in further detail below in connection with FIG. 2) splits the example data 102 and/or data from the local data storage 114 into training subsets, validation subsets, and test subsets with the aim of not only training the machine learning model, but also validating and testing it to check that it is performing properly. In some examples, the example data retriever circuitry 202 (described in further detail below in connection with FIG. 2) causes a distribution of eighty percent of data for training, five percent for validation and fifteen percent for testing. The example environment to train models 100 also includes the processor platform(s) 108 of the illustrated example. The processor platform(s) 108 includes a communication device, such as a transmitter, a receiver, a transceiver, a modem, a residential gateway, a wireless access point, and/or a network interface to facilitate exchange of data with external machines (e.g., computing devices of any kind) by the example network 106. As described in further detail below, the processor platform(s) 108 include the model management circuitry 110, any number of production environments 112, local data storage 114 (e.g., and/or data from any other source(s)), and the processing circuit(s) 116 that operate to train and retrain models (e.g., artificial intelligence models, machine learning models, gain/loss function models, etc.).

In operation, the example model management circuitry 110 trains and retrains models and, when appropriate, sends an alert when model retraining is required. When an indication, signal and/or trigger to train or retrain is detected, retrieved, received and/or obtained by the model management circuitry 110, it first tests performance metrics of the model of interest. If the model satisfies one or more thresholds corresponding to the performance metrics, the model is permitted to run until the next retraining request is detected, retrieved, received and/or obtained. If the one or more thresholds corresponding to performance metrics are not satisfied (e.g., an indication that the model is not performing in view of acceptable metrics or threshold performance values), the model management circuitry 110 enables and/or otherwise permits training/re-training and, in some examples downloads and/or otherwise obtains data 102 from the database 104 to assist with the model retraining process (e.g., by obtaining model parameters, updated coefficients, if any). The model management circuitry 110 blocks the retrain procedure initiated and/or otherwise instantiated by the production environment 112 and/or the processor platform(s) 108, and requires the models to be tested before the retraining is permitted to execute. Thus, due to the amount of computational energy required to train models (e.g., model training corresponding to AI/ML models), blocking the retrain procedure saves energy.

FIG. 2 illustrates additional detail corresponding to the example model management circuitry 110 of FIG. 1. In the illustrated example of FIG. 2, the model management circuitry 110 includes data retriever circuitry 202, train circuitry 204, model distribution circuitry 206, train detection circuitry 208, blocker circuitry 210, performance metric circuitry 212, score generator circuitry 214, and resource evaluation circuitry 216.

FIG. 2 is a block diagram of the example model management circuitry 110 to train and retrain artificial intelligence and/or machine learning models. The model management circuitry 110 of FIG. 2 may be instantiated (e.g., creating an instance of, bring into being for any length of time, materialize, implement, etc.) by processor circuitry such as a central processing unit executing instructions. Additionally, or alternatively, the model management circuitry 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

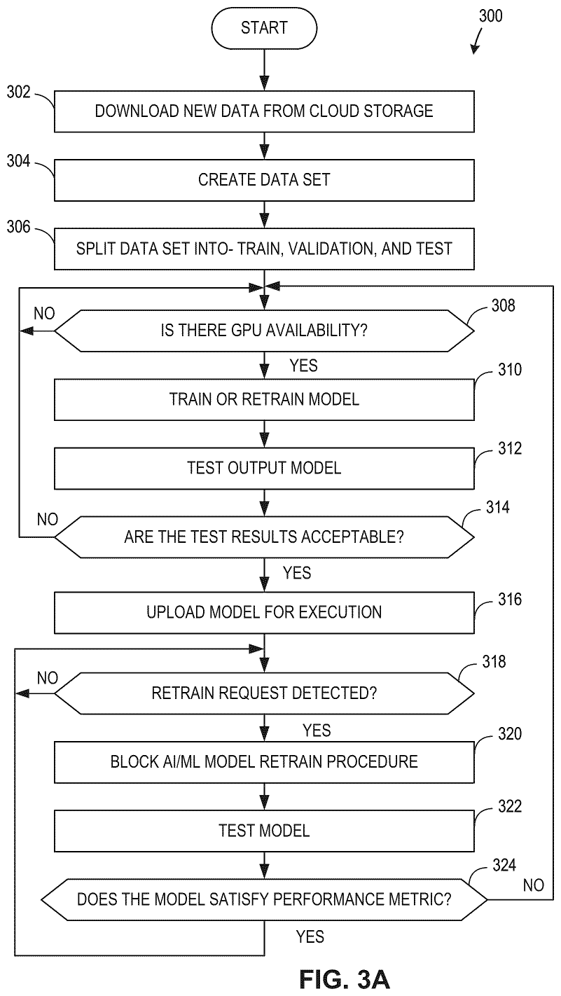

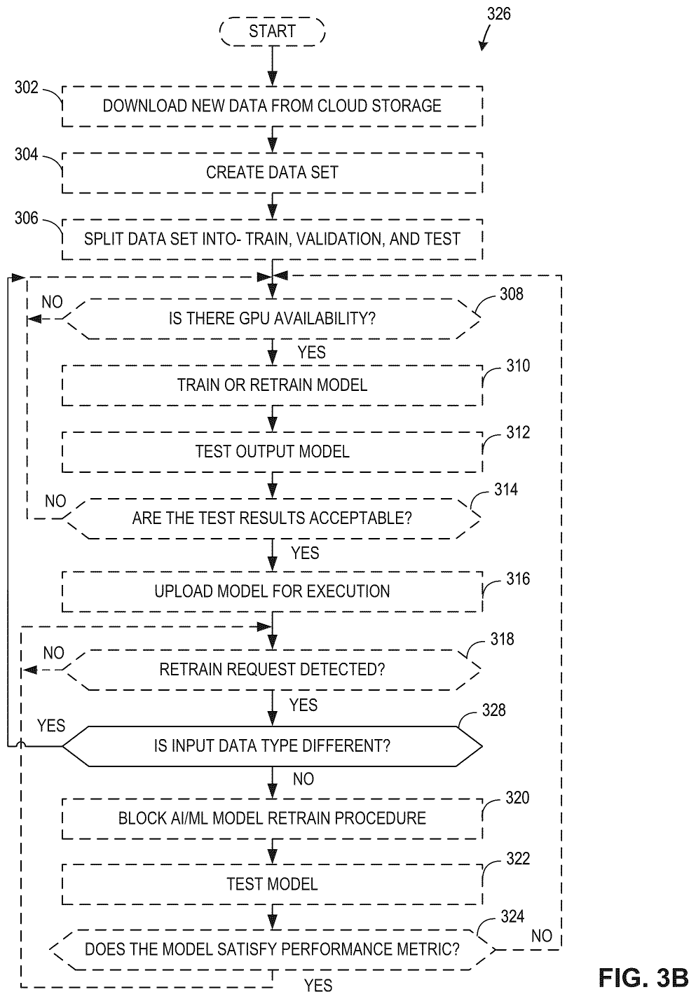

The model management circuitry 110 includes data retriever circuitry 202 which retrieves data 102 from the database 104. The database 104 may be implemented as any type of storage device (e.g., cloud storage, local storage, or network storage). In some examples, the data retriever circuitry 202 is instantiated by processor circuitry executing data retriever instructions and/or configured to perform operations such as those represented by the flowcharts of FIGS. 3A and 3B, discussed in further detail below. The model management circuitry 110 also includes training circuitry 204 to train or retrain models. In some examples, the training circuitry 204 is instantiated by processor circuitry executing training instructions and/or configured to perform operations such as those represented by the flowcharts of FIGS. 3A and 3B. The model management circuitry 110 includes model distribution circuitry 206 to upload models to the production environment 112. In some examples, the model distribution circuitry 206 is instantiated by processor circuitry executing model distribution instructions and/or configured to perform operations such as those represented by the flowcharts of FIGS. 3A and 3B. The model management circuitry 110 includes train detection circuitry 208 to detect, retrieve, receive and/or obtain a training request of the model in the production environment 112. In some examples, the train detection circuitry 208 is instantiated by processor circuitry executing train detection instructions and/or configured to perform operations such as those represented by the flowcharts of FIGS. 3A and 3B. The example blocker circuitry 210 intercepts, responds to, and/or overrides a request to train or retrain the model in the production environment 112. In some examples, the blocker circuitry 210 is instantiated by processor circuitry executing blocker instructions and/or configured to perform operations such as those represented by the flowcharts of FIGS. 3A and 3B.

Additionally, the model management circuitry 110 includes the performance metrics circuitry 212 that is implemented to calculate, evaluate, assess, and/or analyze performance metrics corresponding to model execution. The model management circuitry 110 includes score generator circuitry 214 to compare and/or assess current performance metrics of the model to the threshold performance metrics of the model. If the performance metrics satisfy threshold values (e.g., an indication that the model is performing within desired expectations), then the blocker circuitry 210 prevents and/or otherwise blocks one or more train or retraining requests from executing. The score generator circuitry 214 maintains and/or sustains the block of the retraining until the performance metrics do not meet the threshold. However, if the performance metrics do not meet threshold values (e.g., an indication that the model is underperforming and/or otherwise failing to satisfy desired expectations), then the score generator circuitry 214 permits and/or enables the train or retraining request to allow the model to be trained or retrained. In some examples, the performance metric circuitry 212 is instantiated by processor circuitry executing performance metric instructions and/or configured to perform operations such as those represented by the flowcharts of FIGS. 3A and 3B. In addition, in some examples, the score generator circuitry 214 is instantiated by processor circuitry executing score generator instructions and/or configured to perform operations such as those represented by the flowcharts of FIGS. 3A and 3B. In some examples, the resource evaluation circuitry 216 is instantiated by processor circuitry executing resource evaluation instructions and/or configured to perform operations such as those represented by the flowcharts of FIGS. 3A and 3B.

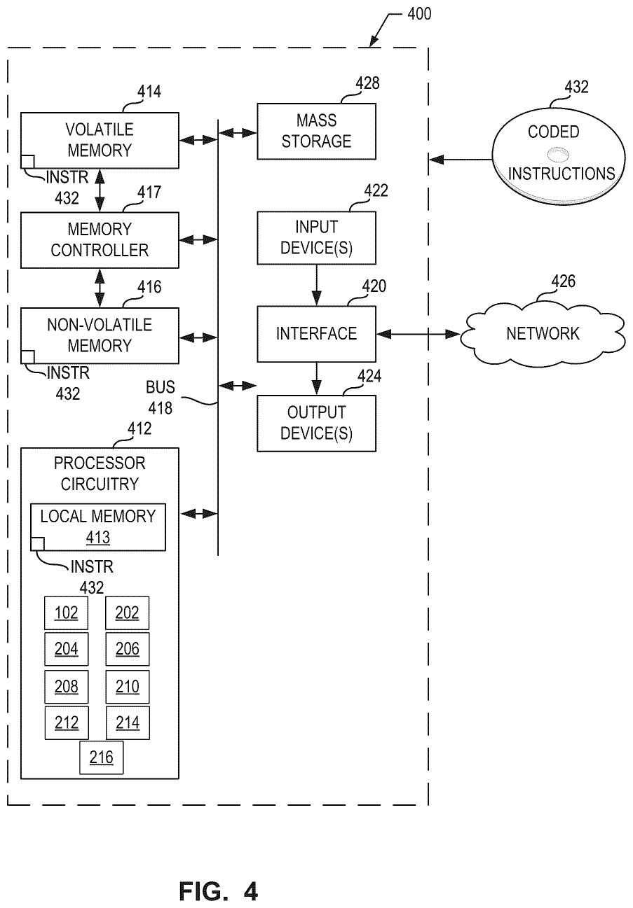

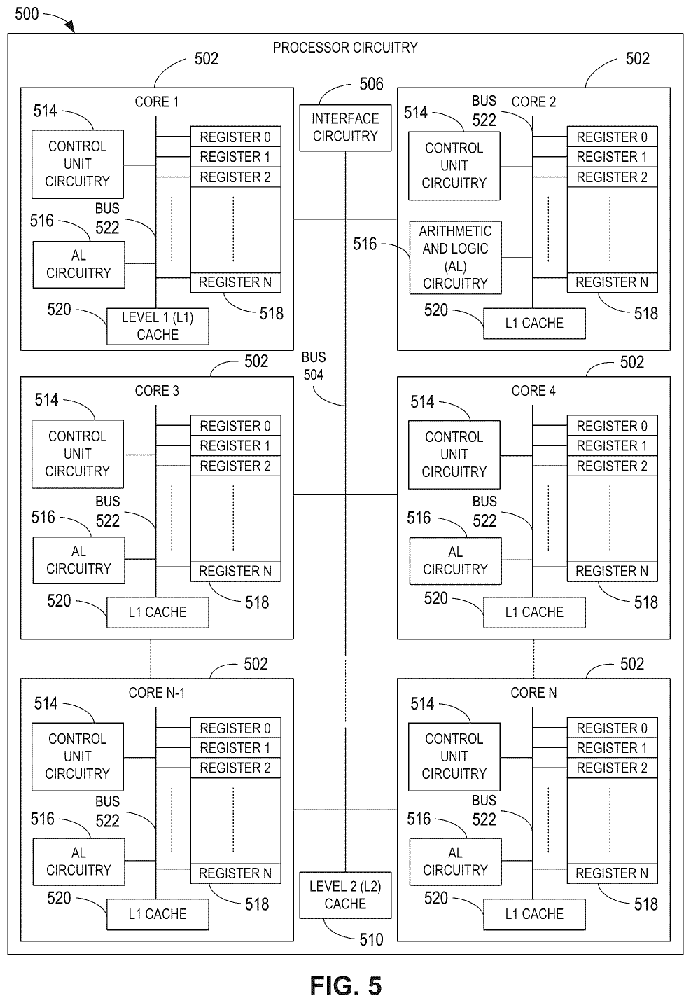

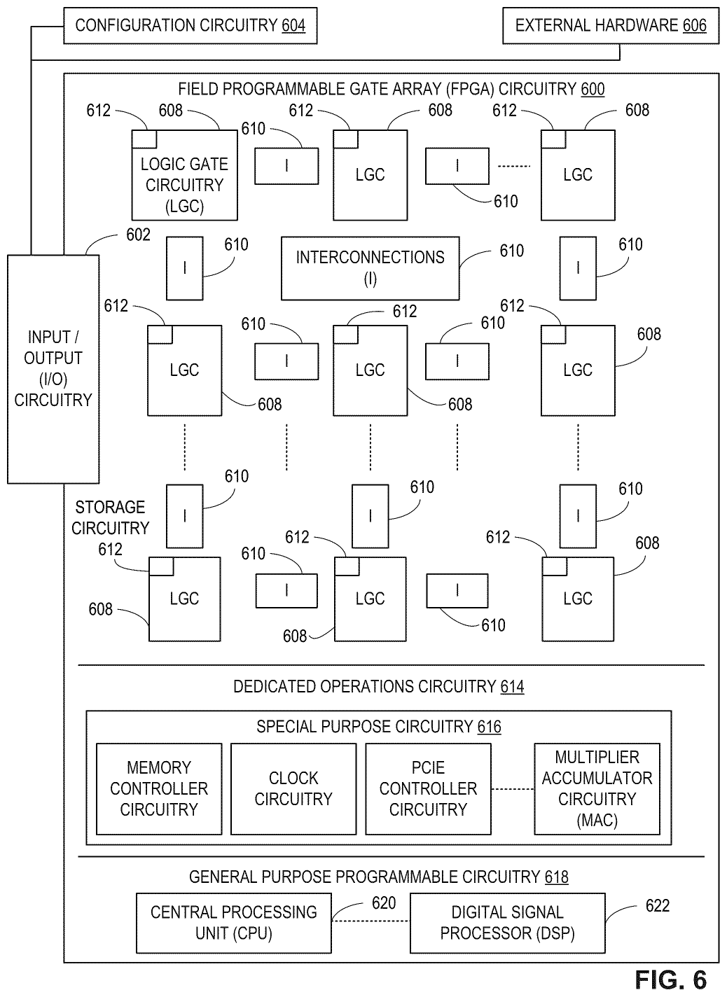

In some examples, the model management circuitry 110 includes means for retrieving data, means for training, means for distributing models, means for detecting training requests, means for blocking, means for determining performance metrics, means for generating scores, and means for evaluating resources. For example, the aforementioned means may be implemented by, respectively, the example data retriever circuitry 202, the example training circuitry 204, the example model distribution circuitry 206, the example train detection circuitry 208, the example blocker circuitry 210, the example performance metric circuitry 212, the example score generator circuitry 214, and the example resource evaluation circuitry 216. In some examples, the aforementioned circuitry may be instantiated by processor circuitry such as the example processor circuitry 412 of FIG. 4. For instance, the aforementioned circuitry may be instantiated by the example microprocessor 500 of FIG. 5 executing machine executable instructions such as those implemented by at least blocks of FIGS. 3A and/or 3B. In some examples, the aforementioned circuitry may be instantiated by hardware logic circuitry, which may be implemented by an ASIC, XPU, or the FPGA circuitry 600 of FIG. 6 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In operation, the following example assumes that models to be executed have not previously been trained at least one time. As such, the example model management circuitry 110 invokes the data retriever circuitry 202 to download and/or otherwise obtain data 102 from the database 104. For example, while the processor platform(s) 108 is executing and/or instantiating the production environment 112 to execute one or more processes that utilize, evaluate and/or otherwise execute models (e.g., models stored in the example database 104 that are available and may be retrieved by the model distribution circuitry 206), the data retriever circuitry 202 ensures that the model(s) are provided with data (e.g., model parameters, coefficient values, raw data, such as field data) for processing and training. In addition, the data retriever circuitry 202 splits the data 102 and/or data within the example local data storage 114 into train, validation, and test subsets. In some examples, the data retriever circuitry 202 distributes the example data 102 accordingly: e.g., eighty percent dedicated for training, five percent dedicated for validation, and fifteen percent dedicated to test.

The example model management circuitry 110 invokes the training circuitry 204 to train or retrain models. In some examples, the training circuitry 204 initiates resource evaluation circuitry 216 to detect and/or evaluate for available computing resources (e.g., available GPU resources, available CPU resources, etc.) capable of executing model training tasks. The resource evaluation circuitry 216 evaluates the available processing resources of the processor platform(s) 108 to identify the type of available computing resources, how many computing resources are available, and current demand for those computing resources. In some examples, the resource evaluation circuitry 216 queries a performance monitoring unit (PMU) with fixed and/or programmable counters to determine performance metrics associated with the computing device (e.g., a CPU, a GPU, etc.). If the example resource evaluation circuitry 216 detects insufficient available computing resources (e.g., insufficient GPU resources, a PMU indication that the GPU is fully utilized by other processes, metrics associated with a utilization metric, metrics associated with a percentage value of available processing resources and/or storage resources, etc.), the computing resources (e.g., GPU circuitry, CPU circuitry, the example processing circuits 116, etc.), the example resource evaluation circuitry 216 will run on a loop until sufficient computing resources are identified. If the example resource evaluation circuitry detects sufficient computing resources (e.g., an indication that a CPU has 50% processor utilization), the training circuitry 204 will train or retrain the model.

In some examples, trainable data is used to train or retrain the model and generate a desired output (e.g., updated model coefficient values). Trainable data, in some examples, is manually labeled data (e.g., receipts, invoices, images, etc.). During training or retraining, the training circuitry 204 invokes the data retriever circuitry 202 to download the labeled data (e.g., manually labeled, labeled from one or more auto-machine learning techniques, etc.) from storage (e.g., in the cloud, in edge device, etc.) In some examples, a data interchange format that uses human-readable text (e.g., JSON file) stores the labeled data for entity tags position and categories (e.g., descriptions, codes, prices, quantity, language, etc.). For example, entity-tagging machine learning models based on neural networks implement an architecture of artificial neurons that are represented by one or more numerical weights. The numerical weights are updated during the training process by using different samples of labeled data. A loss function is then used to check how accurate the model is in each iteration of the training process. When the loss function is at an acceptable value, training can be halted, and the model is thus ready to predict entity-tagging for new samples.

Once training is complete, a test is completed on the output model to ensure and/or otherwise determine the quality of the model. If the test results are acceptable, the model distribution circuitry 206 is invoked to upload models from the model management circuitry 110 to the production environment 112 for execution. In some examples, the score generator circuitry 214 sets, causes, produces, and/or establishes a first flag corresponding to the model to indicate that the model performs to a satisfactory degree (e.g., performs in a manner consistent with threshold metrics). In some examples, the first flag is a valid flag, which serves as a label to one or more other platforms that may also use the model of interest. Generally speaking, any number of independent platforms (e.g., similar to the example platform(s) 108) may utilize the same model when performing tasks on input data. In the event one of the platforms performs a model evaluation and sets, causes, produces, and/or establishes a flag, all other platforms may benefit from what is learned by the model evaluation and independently decide whether to continue to use the model or perform a retraining. In some examples, the model distribution circuitry 206 shares recently trained and/or retrained models with one or more other platforms 108 and/or stores the updated (retrained) models to a storage device, such as the example database 104 of FIG. 1, thereby allowing the platforms to retrieve the model for their own use/application. In some examples, the score generator circuitry 214 sets, causes, produces, and/or establishes a second flag indicative of model failure (e.g., a failure flag) when performance metrics are not satisfied. As such, those other platforms may decide whether to use the model, wait for a retrained model, or retrain the model locally. The model used by the production environment 112 executes document decoding until a training request is detected from the train detection circuitry 208. In some examples the train detection circuitry 208 detects the initiation of retraining request based on a timed schedule or periodic request. After the detection of the request to train, the model management circuitry 110 invokes the blocker circuitry 210 to block, stop, and/or prevent the model from being trained.

Once the training request is blocked, the model management circuitry 110 invokes the performance metrics circuitry 212 to calculate, evaluate, assess, and/or analyze performance metrics. In some examples, the performance metrics are key performance indicators, known as “KPIs”, which may include a F1 score, precision score, and a recall score. The performance metric circuitry 212 calculates, evaluates, assesses, and/or analyzes the precision score by true positive divided by the sum of true positives plus false positives (e.g., in a manner consistent with example Equation 1). As used herein, true positives are instances where the model correctly predicts positive test results and false positives are instances where the model predicts positive test results where positive conditions do not exist. False negatives are instances where the model wrongly indicates that the tests are negative. The performance metric circuitry 212 also calculates the recall by true positives divided by the sum of true positives plus false negatives (e.g., in a manner consistent with example Equation 2). The F1 score is calculated by the performance metric circuitry 212 as precision multiplied by recall and divided by the sum of precision plus recall, the result then multiplied by two (e.g., in a manner consistent with example Equation 3).

$$Precision = \frac{True Positives}{( True Positive + False Positives )} \qquad Equation 1$$

$$Recall = \frac{True Positives}{( True Positive + False Negatives )} \qquad Equation 2$$

$$F 1 = 2 * \frac{Precision * Recall}{( Precision + Recall )} \qquad Equation 3$$

When the example performance indicators are calculated, evaluated, assessed, and/or analyzed by the performance metric circuitry 212, the model management circuitry 110 signals the score generator circuitry 214 to compare and/or assess the performance metrics calculated, evaluated, assessed, and/or analyzed by the performance metrics circuitry 212 to threshold performance metrics. In some examples, threshold performance metrics are inputs based on confidences associated with entity tagging predictions, and a threshold can be set to define an acceptable predication exceeding the defined threshold. If performance metrics satisfy the threshold performance metrics, then the example processor platform(s) 108 is permitted to execute the model until the train detection circuitry 208 detects, retrieves, receives and/or obtains a new request to retrain model (e.g., a request from the PMU of the processor platform(s) 108 indicative of a training request). If performance metrics do not satisfy threshold performance metrics, the model management circuitry 110 permits the retraining request to allow the model in the production environment 112 to be retrained.

This prevention of unnecessarily training models avoids manual work, reduces errors, frees time for engineers to work on more important tasks, and saves energy by avoiding training which requires consumption of computational resources (e.g., GPU resources).

While an example manner of implementing the environment to train models 100 of FIG. 1 is illustrated in FIG. 2, one or more of the elements, processes, and/or devices illustrated in FIG. 2 may be combined, divided, re-arranged, omitted, eliminated, and/or implemented in any other way. Further, the example model management circuitry 110, the data retriever circuitry 202, the train circuitry 204, the model distribution circuitry 206, the train detection circuitry 208, the blocker circuitry 210, the performance metric circuitry 212, the score generator circuitry 214, the resource evaluation circuitry 216, and/or, more generally, the example environment to train models 100 of FIG. 1, may be implemented by hardware alone or by hardware in combination with software and/or firmware. Thus, for example, any of the example the example model management circuitry 110, the data retriever circuitry 202, the train circuitry 204, the model distribution circuitry 206, the train detection circuitry 208, the blocker circuitry 210, the performance metric circuitry 212, the score generator circuitry 214, the resource evaluation circuitry 216, and/or, more generally, the example environment to train models 100, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example environment to train models 100 of FIG. 1 may include one or more elements, processes, and/or devices in addition to, or instead of, those illustrated in FIGS. 1 and/or 2, and/or may include more than one of any or all of the illustrated elements, processes and devices.

Flowcharts representative of example machine readable instructions, which may be executed to configure processor circuitry to implement the environment to train models of FIGS. 1-2, are shown in FIGS. 3A and 3B. The machine readable instructions may be one or more executable programs or portion(s) of an executable program for execution by processor circuitry, such as the processor circuitry 412 shown in the example processor platform 400 discussed below in connection with FIG. 4 and/or the example processor circuitry discussed below in connection with FIGS. 5 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3A and 3B, many other methods of implementing the example environment to train models 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3A and 3B may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIGS. 3A and 3B are flowcharts representative of example machine readable instructions and/or example operations 300 and 326 that may be executed and/or instantiated by processor circuitry to train and retrain models (e.g., document decoding models). The machine-readable instructions and/or the operations 300 and 326 of FIGS. 3A and 3B begin at block 302, at which the data retriever circuitry 202 downloads data 102 (e.g., image data, image data with embedded text, etc.) from storage (e.g., the example database 104, the local data storage 114, etc.) (block 302), creates a data set (block 304), and splits the data set into subsets train, validation, and test (block 306). The example resource evaluation circuitry 216 checks the availability of computing resources corresponding to the processor platform(s) 108 (e.g., GPU resources, CPU resources, etc.) (block 308) and if there are not enough available computing resources detected, the example resource evaluation circuitry 216 causes the process to loop while checking the availability of computing resources that may become available at a future time. On the other hand, if the example resource evaluation circuitry 216 determines that there are enough computing resources (e.g., GPU resources) available (block 308), then the example train circuitry 204 trains or retrains the model (block 310). The example performance metric circuitry 212 tests the output model (block 312), and the example score generator circuitry 214 checks rules (e.g., performance metrics and corresponding threshold values) to determine if the test results are acceptable (block 314) based on established thresholds.

If the test results are determined not acceptable based on established thresholds, then the train circuitry 204 returns to block 308 and checks whether there are available processing resources (e.g., GPU) to start one or more retraining processes. If the test results are determined acceptable, the model distribution circuitry 206 is engaged and uploads the tested (e.g., vetted) model for execution (block 316). The example train detection circuitry 208 detects for a retrain request (block 318). If the train detection circuitry 208 detects, retrieves, receives and/or obtains a request to retrain (block 318), then the blocker circuitry 210 is engaged to block the model retraining procedure (block 320). Stated differently, examples disclosed herein do not permit retraining requests to complete unless an objective need for a retraining effort has been confirmed. Generally speaking, current implementations of model execution may include default retraining schedules that operate on a periodic or scheduled basis absent any regard for need. As such, energy savings results by avoiding computationally intensive retraining tasks when they are unnecessary.

Once the retraining is blocked, the performance metric circuitry 212 is invoked to test the model and generates performance metrics (block 322). Using the score generator circuitry 214, the performance metrics calculated in block 322 are checked against input performance metrics (block 324), and if the performance metrics calculated satisfy the input performance metrics (e.g., thresholds associated with such metrics), then the example programs 300 and 326 of FIGS. 3A and 3B operate in a loop waiting for the train detection circuitry 208 to request a retrain procedure. If the performance metrics calculated do not satisfy the input performance metrics, then the train circuitry 204 is invoked to test for computing resource (e.g., GPU) availability (block 308) and start the retraining process.

FIG. 3B illustrates machine-readable instructions and/or operations 326 in connection with additional capabilities of examples disclosed herein. In the illustrated example of FIG. 3B, portions of the operations 326 shown in dashed lines are substantially similar to the illustrated example of FIG. 3A and will not be discussed again. While examples disclosed above in connection with FIG. 3A illustrate an effort to block retraining tasks unless one or more tests can be performed on the model to verify its performance, examples associated with FIG. 3B consider a circumstance where the input data to be used with the model includes one or more indications that retraining is appropriate without first verifying model performance metrics. To illustrate, consider a trained model that expects and/or otherwise normally operates using input data having images and text in the English language embedded therein. Once such a model is trained, it is expected to perform within threshold limits to extract the English text. However, consider a circumstance where the input data changes such that the language embedded in the image input data is not English, but Spanish. Even without testing the model performance, because the type of input data is substantially different, the model performance is not expected to meet expectations. As such, model retraining is deemed appropriate without initial testing of the model's performance based on the change in input data.

In view of the example scenario above, the example train detection circuitry 208, after detecting a retrain request (block 318), will additionally detect for alternate input data types (e.g., foreign characters (e.g., alternate language, alternate currency symbols, etc.)) (block 328). If the example train detection circuitry 208 does detect a foreign input data type (block 328), then the train circuitry 204 invokes the resource evaluation circuitry 216 to determine and/or verify if there are enough computing resources (e.g., GPU resources) available (block 308), thus, permitting the retrain procedure to execute. However, if an alternate input data type is not detected (block 328) (e.g., new images to analyze are detected, but they include of the same input data type(s)), then the train detection circuitry 208 invokes the blocker circuitry 210 to block the model retraining procedure (block 320).

Alternate input data types that may trigger model retraining without first testing model performance include, but are not limited to alternate languages in the input data, alternate currency types in the input data, alternate image data types (e.g., bitmap images, graphics interchange format (GIF) images, tagged image file format (TIFF) images, joint photographic experts group (JPEG) images, portable network graphics (PNG) images, etc.). In some examples, the data retriever circuitry 202 analyzes input data after each instance of a retraining request for indications of input data type changes from a prior iteration or execution of the model. In some examples, the input data includes header fields and/or metadata indicative of one or more data types that are detected by the data retriever circuitry 202 and compared against a prior data type that was being processed by the model. In response to input data type changes, retraining requests are permitted to execute, as described above.

FIG. 4 is a block diagram of an example processor platform 400 structured to execute and/or instantiate the machine readable instructions and/or the operations of FIGS. 3A and 3B to implement the environment to train models 100 of FIGS. 1-2. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a set top box, or any other type of computing device.

The processor platform 400 of the illustrated example includes processor circuitry 412. The processor circuitry 412 of the illustrated example is hardware. For example, the processor circuitry 412 can be implemented by one or more integrated circuits, logic circuits, FPGAs, microprocessors, CPUs, GPUs, DSPs, and/or microcontrollers from any desired family or manufacturer. The processor circuitry 412 may be implemented by one or more semiconductor based (e.g., silicon based) devices. In this example, the processor circuitry 412 implements the data retriever circuitry 202, the train circuitry 204, the model distribution circuitry 206, the train detection circuitry 208, the blocker circuitry 210, the performance metric circuitry 212, the score generator circuitry 214, and the resource evaluation circuitry 216.

The processor circuitry 412 of the illustrated example includes a local memory 413 (e.g., a cache, registers, etc.). The processor circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The processor platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user to enter data and/or commands into the processor circuitry 412. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 432, which may be implemented by the machine readable instructions of FIGS. 3A and/or 3B, may be stored in the mass storage device 428, in the volatile memory 414, in the non-volatile memory 416, and/or on a removable non-transitory computer readable storage medium such as a CD or DVD.

FIG. 5 is a block diagram of an example implementation of the processor circuitry 412 of FIG. 4. In this example, the processor circuitry 412 of FIG. 4 is implemented by a microprocessor 500. For example, the microprocessor 500 may be a general purpose microprocessor (e.g., general purpose microprocessor circuitry). The microprocessor 500 executes some or all of the machine readable instructions of the flowcharts of FIGS. 3A and 3B to effectively instantiate the model management circuitry 110 of FIGS. 1 and 2 as logic circuits to perform the operations corresponding to those machine readable instructions. In some such examples, the model management circuitry 110 is instantiated by the hardware circuits of the microprocessor 500 in combination with the instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIGS. 3A and 3B.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating point operations. In yet other examples, the AL circuitry 516 may include first AL circuitry that performs integer based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may be implemented by at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 6 is a block diagram of another example implementation of the processor circuitry 412 of FIG. 4. In this example, the processor circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 500 of FIG. 5 described above (which is a general purpose device that may be programmed to execute some or all of the machine readable instructions represented by the flowcharts of FIGS. 3A and 3B but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowcharts of FIGS. 3A and 3B. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowcharts of FIGS. 3A and 3B. As such, the FPGA circuitry 600 may be structured to effectively instantiate some or all of the machine readable instructions of the flowcharts of FIGS. 3A and 3B as dedicated logic circuits to perform the operations corresponding to those software instructions in a dedicated manner analogous to an ASIC. Therefore, the FPGA circuitry 600 may perform the operations corresponding to the some or all of the machine readable instructions of FIGS. 3A and 3B faster than the general purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain machine readable instructions to configure the FPGA circuitry 600, or portion(s) thereof. In some such examples, the configuration circuitry 604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may be implemented by external hardware circuitry. For example, the external hardware 606 may be implemented by the microprocessor 500 of FIG. 5. The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations that may correspond to at least some of the machine readable instructions of FIGS. 3A and 3B and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowcharts of FIGS. 3A and 3B may be executed by one or more of the cores 502 of FIG. 5, a second portion of the machine readable instructions represented by the flowcharts of FIGS. 3A and 3B may be executed by the FPGA circuitry 600 of FIG. 6, and/or a third portion of the machine readable instructions represented by the flowcharts of FIGS. 3A and 3B may be executed by an ASIC. It should be understood that some or all of the circuitry of FIGS. 1 and/or 2 may, thus, be instantiated at the same or different times. Some or all of the circuitry may be instantiated, for example, in one or more threads executing concurrently and/or in series. Moreover, in some examples, some or all of the circuitry of FIGS. 1 and/or 2 may be implemented within one or more virtual machines and/or containers executing on the microprocessor.

In some examples, the processor circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

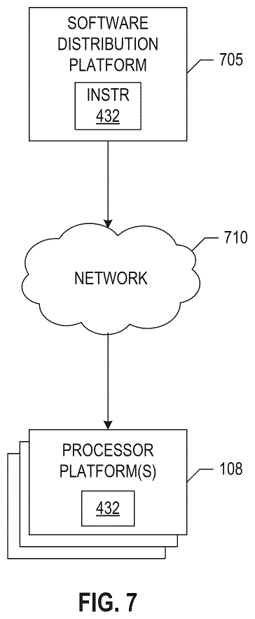

A block diagram illustrating an example software distribution platform 705 to distribute software such as the example machine readable instructions 432 of FIG. 4 to hardware devices owned and/or operated by third parties is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions 300 and 326 of FIGS. 3A and 3B, as described above. The one or more servers of the example software distribution platform 705 are in communication with an example network 410, which may correspond to any one or more of the Internet and/or any of the example networks 426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions 300 and 326 of FIGS. 3A and 3B, may be downloaded to the example processor platform 400, which is to execute the machine readable instructions 432 to implement the model management circuitry 110. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices.

From the foregoing, it will be appreciated that example systems, methods, apparatus, and articles of manufacture have been disclosed that reduce the unnecessary consumption of computing resources in circumstances where models are utilized. Because examples disclosed herein do not blindly allow automatic retraining of models without any objective indication that such retraining is needed, computing resources are conserved that would have otherwise been wasted on retraining efforts when current model parameters (e.g., coefficients) perform to a satisfactory degree. Disclosed systems, methods, apparatus, and articles of manufacture improve, enhance, increase, and/or boost the efficiency of using a computing device by blocking the retraining of machine learning models when model performance is meeting acceptable metrics. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to manage training for machine learning models are disclosed herein. Further examples and combinations thereof include the following:

Example 1 includes an apparatus to improve model training efficiency comprising train detection circuitry to detect a training request of a model, blocker circuitry to, in response to detection of the training request, block the model from being retrained, performance metric circuitry to calculate at least one performance metric corresponding to the model, and score generator circuitry to improve the model efficiency by comparing the at least one performance metric corresponding to current model execution to at least one threshold performance metric, and one of (a) maintaining the block of the re-training request when the threshold performance metric is satisfied or (b) permitting the re-training request to cause the model to be retrained when the threshold performance metric is not satisfied.

Example 2 includes the apparatus as defined in example 1, wherein the score generator circuitry is to set a first flag corresponding to the model when the threshold performance metric is satisfied, the first flag indicative of satisfactory model performance, and set a second flag corresponding to the model when the threshold performance metric is not satisfied, the second flag indicative of poor model performance.

Example 3 includes the apparatus as defined in example 1, further including resource evaluation circuitry to determine availability metrics corresponding to process circuitry.

Example 4 includes the apparatus as defined in example 3, wherein the resource evaluation circuitry is to query a performance monitoring unit (PMU) corresponding to the process circuitry to identify a processing utilization metric.

Example 5 includes an apparatus as defined in example 1, wherein the performance metric(s) include key performance indicators.

Example 6 includes an apparatus as defined in example 5, wherein the key performance indicators include at least one of precision, recall, and/or a F1-score.

Example 7 includes an apparatus as defined in example 1, wherein process circuitry is to train or re-train models.

Example 8 includes an apparatus as defined in example 7, wherein the process circuitry includes at least one of a central processing unit (CPU), a graphical processing unit (GPU), or a field-programmable gate array (FPGA).

Example 9 includes an apparatus to improve model training efficiency comprising at least one memory, machine readable instructions, and processor circuitry to at least one of instantiate or execute the machine readable instructions to obtain a training request corresponding to a model, override the training request to prevent the model from being retrained, assess at least one performance metric corresponding to the model, enhance the model efficiency by assessing the at least one performance metric corresponding to current model execution to at least one threshold performance metric, and one of (a) sustaining the block of the re-training request when the threshold performance metric is satisfied or (b) enabling the re-training request to cause the model to be retrained when the threshold performance metric is not satisfied.

Example 10 includes the apparatus as defined in example 9, wherein the processor circuitry is to cause a first flag corresponding to the model to be established when the threshold performance metric is satisfied, the first flag indicative of satisfactory model performance, and cause a second flag corresponding to the model to be established when the threshold performance metric is not satisfied, the second flag indicative of poor model performance.

Example 11 includes the apparatus as defined in example 9, wherein the processor circuitry is to verify availability metrics.

Example 12 includes the apparatus as defined in example 11, wherein the processor circuitry is to query a performance monitoring unit (PMU) corresponding to the processor circuitry to identify a processing utilization metric.

Example 13 includes an apparatus as defined in example 9, wherein the performance metric(s) include key performance indicators.

Example 14 includes an apparatus as defined in example 12, wherein the key performance indicators include at least one of precision, recall, and/or a F1-score.

Example 15 includes an apparatus as defined in example 9, wherein the processor circuitry is to train or retrain models.

Example 16 includes an apparatus as defined in example 9, wherein the processor circuitry includes at least one of a central processing unit (CPU), a graphical processing unit (GPU), or a field-programmable gate array (FPGA).

Example 17 includes a non-transitory machine readable storage medium comprising instructions that, when executed, cause processor circuitry to at least retrieve a training request of a model, react to obtained training request and prevent the model from being retrained, analyze at least one performance metric corresponding to the model, and enhance the model efficiency by assessing the at least one performance metric corresponding to current model execution to at least one threshold performance metric, and one of (a) maintaining the block of the re-training request when the threshold performance metric is satisfied or (b) permitting the re-training request to cause the model to be retrained when the threshold performance metric is not satisfied.

Example 18 includes the non-transitory machine readable storage medium as defined in example 17, wherein the instructions, when executed, cause the processor circuitry to produce a first flag corresponding to the model when the threshold performance metric is satisfied, the first flag indicative of satisfactory model performance, and produce a second flag corresponding to the model when the threshold performance metric is not satisfied, the second flag indicative of poor model performance.

Example 19 includes the non-transitory machine readable storage medium as defined in example 17, wherein the processor circuitry is to verify availability metrics corresponding thereto.

Example 20 includes the non-transitory machine readable storage medium as defined in example 17, wherein the performance metric(s) include key performance indicators.

Example 21 includes the non-transitory machine readable storage medium as defined in example 20, wherein the key performance indicators include at least one of precision, recall, and/or a F1-score.

Example 22 includes the non-transitory machine readable storage medium as defined in example 17, wherein the processor circuitry is to train or retrain the model.

Example 23 includes the non-transitory machine readable storage medium as defined in example 17, wherein the processor circuitry includes at least one of a central processing unit (CPU), a graphical processing unit (GPU), or a field-programmable gate array (FPGA).

Example 24 includes a method of managing a model, the method comprising obtaining, by executing instructions with at least one processor, a training request of a model, responding, by executing instructions with the at least one processor, to the training request and prevent the model from being retrained, calculating, by executing instructions with the at least one processor, at least one performance metric corresponding to the model, and enhancing the model efficiency by assessing, by executing instructions with the at least one processor, the at least one performance metric corresponding to current model execution to at least one threshold performance metric, and one of (a) sustaining the block of the re-training request when the threshold performance metric is satisfied or (b) enabling the re-training request to cause the model to be retrained when the threshold performance metric is not satisfied.

Example 25 includes the method of example 24, wherein, to compare the value of the performance metrics, the method includes setting a first flag corresponding to the model when the threshold performance metric is satisfied, the first flag indicative of satisfactory model performance, and setting a second flag corresponding to the model when the threshold performance metric is not satisfied, the second flag indicative of poor model performance.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to improve model training efficiency comprising:
train detection circuitry to detect a training request of a model;
blocker circuitry to, in response to detection of the training request, block the model from being retrained;
performance metric circuitry to calculate at least one performance metric corresponding to the model; and
score generator circuitry to improve the model efficiency by:
comparing the at least one performance metric corresponding to current model execution to at least one threshold performance metric; and
one of (a) maintaining the block of the re-training request when the threshold performance metric is satisfied or (b) permitting the re-training request to cause the model to be retrained when the threshold performance metric is not satisfied.

2. The apparatus as defined in claim 1, wherein the score generator circuitry is to:
set a first flag corresponding to the model when the threshold performance metric is satisfied, the first flag indicative of satisfactory model performance; and
set a second flag corresponding to the model when the threshold performance metric is not satisfied, the second flag indicative of poor model performance.

3. The apparatus as defined in claim 1, further including resource evaluation circuitry to determine availability metrics corresponding to process circuitry.

4. The apparatus as defined in claim 3, wherein the resource evaluation circuitry is to query a performance monitoring unit (PMU) corresponding to the process circuitry to identify a processing utilization metric.

5. An apparatus as defined in claim 1, wherein the performance metric(s) include key performance indicators.

6. An apparatus as defined in claim 5, wherein the key performance indicators include at least one of precision, recall, and/or a F1-score.

7. An apparatus as defined in claim 1, wherein process circuitry is to train or re-train models.

8. An apparatus as defined in claim 7, wherein the process circuitry includes at least one of a central processing unit (CPU), a graphical processing unit (GPU), or a field-programmable gate array (FPGA).

9. An apparatus to improve model training efficiency comprising:
at least one memory;
machine readable instructions; and
processor circuitry to at least one of instantiate or execute the machine readable instructions to:
obtain a training request corresponding to a model;
override the training request to prevent the model from being retrained;
assess at least one performance metric corresponding to the model;
enhance the model efficiency by:
assessing the at least one performance metric corresponding to current model execution to at least one threshold performance metric; and
one of (a) sustaining the block of the re-training request when the threshold performance metric is satisfied or (b) enabling the re-training request to cause the model to be retrained when the threshold performance metric is not satisfied.

10. The apparatus as defined in claim 9, wherein the processor circuitry is to:
cause a first flag corresponding to the model to be established when the threshold performance metric is satisfied, the first flag indicative of satisfactory model performance; and
cause a second flag corresponding to the model to be established when the threshold performance metric is not satisfied, the second flag indicative of poor model performance.

11. The apparatus as defined in claim 9, wherein the processor circuitry is to verify availability metrics.

12. The apparatus as defined in claim 11, wherein the processor circuitry is to query a performance monitoring unit (PMU) corresponding to the processor circuitry to identify a processing utilization metric.

13. An apparatus as defined in claim 9, wherein the performance metric(s) include key performance indicators.

14. An apparatus as defined in claim 12, wherein the key performance indicators include at least one of precision, recall, and/or a F1-score.

15. An apparatus as defined in claim 9, wherein the processor circuitry is to train or retrain models.

16. An apparatus as defined in claim 9, wherein the processor circuitry includes at least one of a central processing unit (CPU), a graphical processing unit (GPU), or a field-programmable gate array (FPGA).

17. A non-transitory machine readable storage medium comprising instructions that, when executed, cause processor circuitry to at least:
retrieve a training request of a model;
react to obtained training request and prevent the model from being retrained;
analyze at least one performance metric corresponding to the model; and
enhance the model efficiency by:
assessing the at least one performance metric corresponding to current model execution to at least one threshold performance metric; and
one of (a) maintaining the block of the re-training request when the threshold performance metric is satisfied or (b) permitting the re-training request to cause the model to be retrained when the threshold performance metric is not satisfied.

18. The non-transitory machine readable storage medium as defined in claim 17, wherein the instructions, when executed, cause the processor circuitry to:
produce a first flag corresponding to the model when the threshold performance metric is satisfied, the first flag indicative of satisfactory model performance; and
produce a second flag corresponding to the model when the threshold performance metric is not satisfied, the second flag indicative of poor model performance.

19. The non-transitory machine readable storage medium as defined in claim 17, wherein the processor circuitry is to verify availability metrics corresponding thereto.

20. The non-transitory machine readable storage medium as defined in claim 17, wherein the performance metric(s) include key performance indicators.

21. The non-transitory machine readable storage medium as defined in claim 20, wherein the key performance indicators include at least one of precision, recall, and/or a F1-score.

22. The non-transitory machine readable storage medium as defined in claim 17, wherein the processor circuitry is to train or retrain the model.

23. The non-transitory machine readable storage medium as defined in claim 17, wherein the processor circuitry includes at least one of a central processing unit (CPU), a graphical processing unit (GPU), or a field-programmable gate array (FPGA).

24. A method of managing a model, the method comprising:
obtaining, by executing instructions with at least one processor, a training request of a model;
responding, by executing instructions with the at least one processor, to the training request and prevent the model from being retrained;
calculating, by executing instructions with the at least one processor, at least one performance metric corresponding to the model; and
enhancing the model efficiency by:
assessing, by executing instructions with the at least one processor, the at least one performance metric corresponding to current model execution to at least one threshold performance metric; and
one of (a) sustaining the block of the re-training request when the threshold performance metric is satisfied or (b) enabling the re-training request to cause the model to be retrained when the threshold performance metric is not satisfied.

25. The method of claim 24, wherein, to compare the value of the performance metrics, the method includes:
setting a first flag corresponding to the model when the threshold performance metric is satisfied, the first flag indicative of satisfactory model performance; and
setting a second flag corresponding to the model when the threshold performance metric is not satisfied, the second flag indicative of poor model performance.
